(19) United States
(12) Patent Application Publication
(10) Pub. No.: US 2025/0298781 A1
(43) Pub. Date: Sep. 25, 2025

(54) MULTI-TABLE DATA STORAGE WITH AUDITABLE DATA CHANGES

(71) Applicant: THE TORONTO-DOMINION BANK, TORONTO (CA)

(72) Inventors: Alexander Clarence, TORONTO (CA); Raunaq Suri, Mississauga (CA); Ding Tao Liu, TORONTO (CA); Satya Krishna Gorti, TORONTO (CA); Kin Kwan Leung, TORONTO (CA); Guangwei Yu, TORONTO (CA); Anuar Yeraliyev, TORONTO (CA)

(21) Appl. No.: 19/058,668

(22) Filed: Feb. 20, 2025

Related U.S. Application Data
(60) Provisional application No. 63/567,627, filed on Mar. 20, 2024.

(51) Int. Cl. G06F 16/215; G06F 16/2458

(52) U.S. Cl. CPC G06F 16/215; G06F 16/2477

(57) ABSTRACT

A data management system stores data in a plurality of data tables in relation to unique transaction identifiers stored in a transaction table. The transaction table manages a record for transactions, such that individual transactions may be marked as valid or invalid without modifying or deleting data, thus preserving an auditable data log. When data is transmitted to the data management system for storage, such as from machine-learning model applications, the data management system appends the received data to multiple data tables. When the received data is successfully appended, a corresponding transaction table is updated to include a record of a transaction identifier for the data, the record indicating that the transaction is valid. Subsequent queries are executed on valid transactions, while invalidated or outdated data is still maintained by the data management system for audit purposes.

### CROSS-REFERENCE TO RELATED APPLICATION

This application claims the benefit of U.S. Provisional Application No. 63/567,627, filed Mar. 20, 2024, the contents of which is hereby incorporated by reference in its entirety.

### BACKGROUND

This disclosure relates generally to data storage and management, and more specifically to a system for data storage and management of auditable transactions.

Datasets can be generated and used in various applications to inform decisions or maintain records. While in use, datasets may continue to be updated, for example, upon a new run or “invocation” of a machine learning model to generate a new dataset. As the datasets are updated and queries or processes are executed, it is important for data management systems to maintain data integrity and auditability. For complex processes, such as executing a computer trained model to a batch of data, multiple types of data for storage in multiple data tables may be generated and represent a relatively large amount of data to be updated, across several tables, in one transaction. For example, a single “run” of a computer trained model may generate data for recordation including a set of input data applied to the model, outputs generated for each input record, model configuration and parameters, and the like, to auditably record how the model generated its outputs. As such, maintaining updated datasets requires effective storage across multiple data tables without data corruption or loss of data.

In particular, data management systems in which datasets are saved into multiple data tables (e.g., due to repeated invocations of a machine learning model or other updates to existing datasets) may additionally need to ensure that appends to the multiple data tables are idempotent and update atomically from the perspective of a querying system, thus avoiding partially updated data being returned as query responses. In addition, different updates to the data tables may modify the same and/or different records, such that the applicable data for responding to a query depends on which updates are used in resolving the query. As datasets become larger or more complex, the likelihood of timing issues arising from receiving queries during append processes may increase.

Datasets associated with regulated industries (such as financial institutions) may additionally be subject to strict auditing requirements. As such, it is necessary for data management systems to maintain data even after it is determined to be outdated (e.g., replaced with new or updated data, or otherwise erroneous) as well as to maintain audit logs describing any data changes, including unsuccessful operations or processes. In addition, particular transactions may be subsequently invalidated such that queries to the data tables should roll back the data tables to resolve data queries as though that transaction did not occur.

Often, conventional data management systems are unable to support data integrity to the specification required by regulated industries. For example, conventional data management systems may be unable to support concurrent data writes for datasets, e.g., a single invocation of a machine learning model, or are subsequently unable to rollback erroneous data to prior versions without permanently deleting or removing the erroneous data (and in many cases subsequent transaction data), making audits difficult or impossible. Additionally, conventional data management systems that allow rollback or reversion generally incapable of selectively identifying and rolling back single, select portions of data at a transaction level without reverting the entire database to a prior state.

### SUMMARY

A data management system manages a plurality of data tables storing data in relation to unique transaction identifiers. The data management system uses a transaction table to manage a record for the transactions, such that each transaction may be marked as valid or invalid for use of the related data in the data tables. Queries to the data are resolved with respect to valid transactions in the transaction table, which removes erroneous transactions from appearing as query responses while preserving an auditable data log. When a dataset is created, (e.g., by an invocation of a machine learning model) the dataset may be transmitted to the data management system to be stored. The data management system appends the received dataset to multiple data tables. Each dataset may be considered a transaction, which is associated by the data management system with a unique transaction identifier. The data for a transaction is stored in the respective data tables in association with the transaction identifier. Once data for the transaction is stored to the data tables, the transaction table is updated to include a record of the transaction identifier and other relevant metadata, such that the transaction table may be used as an index for all data included in the multiple data tables and indicate which transactions are valid in the data tables.

Each transaction is additionally associated in the transaction table with a status, which may be valid or invalid. Once storage (e.g., an append) of a transaction to the data table is completed, the transaction is stored in the transaction table as valid, thus enabling the appended data to be available for querying. It may be necessary to mark transactions as invalid for various reasons, such as incomplete append processes, failure to append, failure of one or more other processes to execute, or as being identified as otherwise erroneous (e.g., a later-identified problem with the recorded data set). Invalid transactions remain in the data tables and may be accessed (e.g., for auditing), but are ignored while querying to ensure that only data associated with valid transactions is returned.

When the data management system receives queries, data in the transaction table may be used to identify relevant transactions as the latest transactions (e.g., when multiple transactions correspond to a given machine learning model run) and to filter for valid transactions. As such, although the plurality of data tables includes all prior and/or erroneous transactions, the data management system retrieves only up-to-date and valid data in response to queries. While data storage to each individual data table may be atomic and idempotent, storage across the multiple data tables often is not. By linking validity of the transaction to recordation in the transaction table, data across the plurality of data tables may be made atomic and jointly idempotent from the perspective of data queries to the overall database. The transaction table thus enables coordination of data validity and storage for multiple data tables that may otherwise not be jointly idempotent. In addition, particular transactions may be invalidated to prevent queries from returning related data without requiring complete rollback of the state of the database, enabling subsequent transactions to remain valid.

### BRIEF DESCRIPTION OF THE DRAWINGS

FIG. 1 is an example environment for a data management system, according to one embodiment.

FIG. 2 is an example block diagram of a data management system, according to one embodiment.

FIGS. 3A-D illustrate appending to an example transaction data store, including data tables and transaction tables, according to one embodiment.

FIG. 4 is an example timing diagram for appending new data to a data management system, according to one embodiment.

FIG. 5 is an example timing diagram for querying data from a data management system, according to one embodiment.

FIG. 6 is an example timing diagram for invalidating transactions in a data management system, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

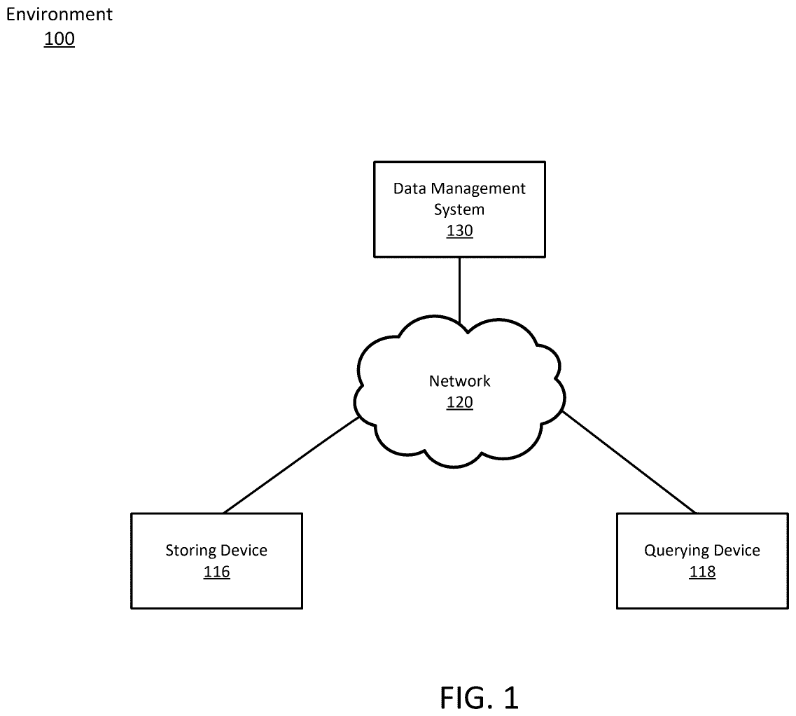

FIG. 1 is an example environment 100 for a data management system 130, according to one embodiment. The data management system 130 stores and maintains data received from one or more storing devices 116 and transmits data to one or more querying devices 118 via a network 120. The network 120 provides a communication channel between the data management system 130 and the storing devices 116 and/or the querying devices 118. In other embodiments, different and/or additional components may be included in the system environment 100, and one or more components may perform different functions.

In the embodiment of FIG. 1, the data management system 130 manages a plurality of data tables storing data in association with an auditable record in a transaction table. The database management system 130 may store data for retrieval according to any suitable database access or querying protocol, such as Structured Query Language (SQL). When data is received from the storing devices 116, the data management system 130 appends them to multiple data tables. In various embodiments, datasets received by the data management system 130 may be large or otherwise complex, including multiple types or formats of data are stored in multiple data tables. For example, the data management system 130 may receive data generated by one or more computer trained models, including inputs, outputs, and configurations and/or parameters of the computer trained models to be stored in corresponding data tables. A particular data set to be stored together may thus represent a given batch of model inputs (e.g., input features for 1,000 to 1 M records), model outputs (1,000 to 1 M records), and model parameters (e.g., 1 Gb to 100Gb+), enabling the particular data acted on by the model and its configuration to be later audited as necessary.

To ensure that idempotency is maintained throughout appends of large or complex datasets, the data management system 130 uses a transaction table to record a validity status of each received dataset, such that data from a received dataset cannot be queried until all data from the dataset is fully stored across the respective data tables. In some embodiments, the data tables of the management system 130 are append-only. The data management system 130 considers each dataset to be a “transaction” that is assigned and subsequently associated with a unique transaction identifier. Once a transaction is successfully appended to the multiple data tables, the data management system 130 updates a transaction table to include a record of the transaction identifier and marks the transaction as valid, enabling data from the transaction to be queried.

As updates are made to the data, the data management system 130 may mark transactions in the transaction table as valid or invalid, further denoting whether the data corresponding to the transactions should be available for querying. When a transaction is marked as invalid, general queries to data stored in the data management system 130 will not access any data corresponding to the transaction identifier for the transaction, whereas marking a transaction as valid makes the corresponding data available for general querying. As previously noted, transactions may be marked as valid, responsive to an append being successfully completed, for example. Transactions may be marked as invalid for various reasons, such as an incomplete append or failure to append, failure of one or more other processes to execute, or being identified as containing incorrect or erroneous data entries. As another example, an error in operation of the computer model or other process associated with or generating the data set may subsequently be identified, such as a computer model failing a later validation, such that the results of the model should no longer be available for querying. Generally, data is valid or invalid at the transaction level, such that transactions may not be marked as partially invalidated or partially valid; thus, individual data entries within transactions cannot be marked as invalid without other data entries within the same transactions as also being invalidated. While invalidated transactions are removed from querying, data entries corresponding to transactions that are marked as invalid are not modified or deleted from the data management system 130 when the data tables are append-only. Because invalid transactions remain in the data tables, the data management system 130 maintains a complete and auditable record of data for industries or instances where full audit logs may be required.

In various embodiments, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 125 may be represented using any suitable format, such as hypertext markup language (HTML) or extensible markup language (XML). In some embodiments, all or some of the communication links of the network 120 may be encrypted using any suitable technique or techniques.

Storing devices 116 and querying devices 118 may be any suitable client device for transmitting and receiving data via the network 120. As examples, storing devices 116 and querying devices 118 may be a desktop or laptop computer or server terminal as well as mobile devices, touchscreen displays, or other types of devices which can exchange data with the data management system 130. In some embodiments, functions of the storing device 116 and querying device 118 may be performed by a single client device communicatively connected to the data management system 130 via the network 120.

Storing devices 116 transmit data to be stored in the data management system 130. In various embodiments, storing devices 116 may include one or more upstream processes for generating data, such as devices applying trained computer models. For example, storing devices 116 may apply one or more of: a generalized linear model, a generalized additive model, a random forest classifier, a spatial regression operation, a Bayesian regression model, a time series analysis, a Bayesian network, a Gaussian network, a decision tree learning operation, an artificial neural network, a recurrent neural network, a reinforcement learning operation, linear or non-linear regression operations, clustering operations, support vector machines, or genetic algorithm operations.

Data generated by these computer trained models or machine learning operations may be applied in various contexts, fields, or industries, and may be applied more than once or periodically, such that new data is generated by the storing devices 116 on a regular or semi-regular basis. For example, storing devices 116 in medical contexts may use computer trained models for medical imaging predictions or patient mortality predictions, requiring a data management system 130 to store data describing extensive imaging data, convolutional layer parameters, or large amounts of patient records. As new input information is acquired (e.g., new patient information or records, updated imaging), storing devices 116 may re-run computer trained models to generate updated predictions. In another example, storing devices 116 may require a data management system 130 to store data for training models, and may require the data management system to maintain large amounts of training data and parameters. As additional training data is discovered or flaws in existing computer models are discovered, storing devices 116 may modify parameters or configurations for computer models, such that previously generated predictions become outdated.

In other embodiments, storing devices 116 may be intermediate devices which receive data from other one or more sources and transmit the received data to the data management system 130. Data sent by the storing devices 116 may be data to be stored into data tables by the data management system 130 or may be updates to validity statuses of existing data stored by the data management system. For example, storing devices 116 may identify a previously stored transaction as invalid (e.g., due to containing errors or to becoming outdated) and transmit a request to mark the transaction as invalid in a transaction table associated with the data. In additional examples, additional systems (e.g., auditing or validation systems not shown in FIG. 1) may generate and send requests to modify validity of a transaction to the data management system 130.

Querying devices 118 transmit queries to the data management system 130 to be applied to the stored data and receive query responses. Queries may request portions of stored data relevant to one or more downstream processes, such as, for example, outputs of a trained computer model stored by the data management system 130, which may be applied to inform decisions or to be further processed in one or more downstream processes. In some embodiments, queries may additionally request audit logs, e.g., to satisfy auditing requirements for regulated industries such as financial institutions, which may describe all data changes, such as appends, processes, and modifications to data validity performed on data stored by the data management system 130. Audit logs may include data stored by the data management system 130 in one or more transaction tables and may additionally or instead include some or all data stored to the plurality of data tables, including outdated or otherwise invalidated data.

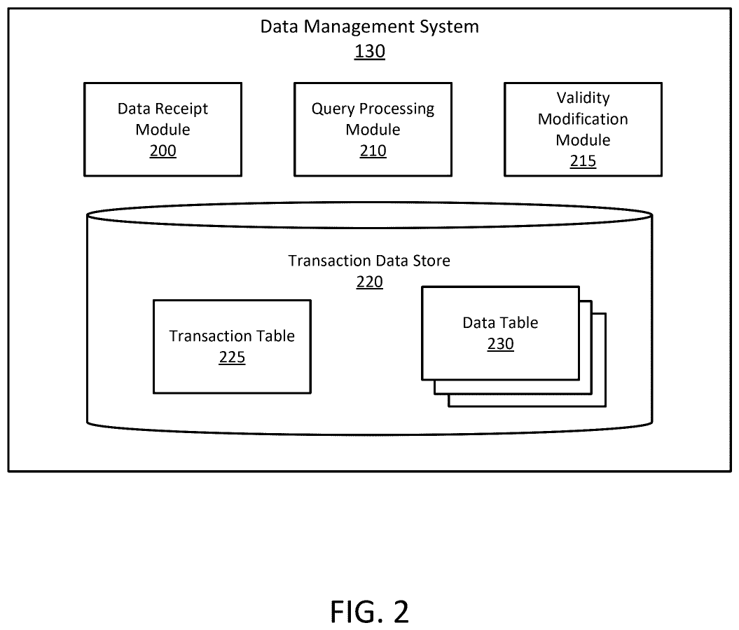

FIG. 2 is an example block diagram of a data management system 130, according to one embodiment. The data management system 130 comprises a data receipt module 200, a query processing module 210, a validity modification module 215, and a transaction data store 220. In other embodiments, different and/or additional components may be included in the data management system 130.

The data receipt module 200 receives data from one or more storing devices 116 via a network, such as the network 120 of FIG. 1. In various embodiments, data received by the data receipt module 200 may include data for storage by the data management system 130. Each set of received data may comprise multiple data types and data for storage across multiple data tables. For example, the data may include inputs and outputs from a model, as well as metadata, parameters, or configuration data associated with a model at the time of data generation. In another example, the data may include one or more record identifiers for identifying or accessing the data by downstream querying.

Responsive to receiving data for storage by the data management system 130, the data receipt module 200 generates a unique transaction identifier for the data and appends the received data to a plurality of data tables 230 of the transaction data store 220. The plurality of data tables 230 are not jointly idempotent, and as such the data is not simultaneously appended. As such, even if requests to store data are sent in parallel to the data tables 230, the different data tables may complete recordation of the data at different times and, from the perspective of an individual data table, be able to respond to queries with the transaction's appended data at different times. As discussed further below, the transaction table 225 can provide joint idempotency to the transaction as a whole, such that the data across the plurality of data tables 230 is atomically added at the transaction level and, via the transaction identifier, the same dataset is added one time across the plurality of data tables. In some embodiments, the data receipt module 200 appends the received data to the plurality of data tables 230 sequentially, such that a first data entry is appended to a first data table of the plurality of data tables, a second data entry is appended to a second data table of the plurality of data tables responsive to the first data entry being successfully appended, and so forth. In other embodiments, the data receipt module 200 appends the received data to the plurality of data tables non-sequentially or without requiring a successful append of a first data entry to initiate appending a second data entry.

When all data entries of the set of received data are successfully appended to the plurality of data tables 230, the data receipt module 200 creates a record for the transaction to be inserted to a transaction table 225 of the transaction data store 220. The record for the transaction includes transaction metadata describing the stored data, including, for example, the unique transaction identifier generated by the data receipt module 200, a timestamp corresponding to the successful append of the data, and a validity status of the transactions. By inserting the record to the transaction table 225 including a “valid” status of the newly appended data entries, the data receipt module 200 enables the data entries to be retrieved for querying. Said another way, when data for a transaction is added to data tables but not yet associated with a “valid” transaction in the transaction table, that data is not used to respond to received queries.

The query processing module 210 receives queries from one or more querying devices 118 and applies the queries to data stored in the transaction data store 220 to generate query responses. Queries received by the query processing module 210 may request data entries corresponding to particular records, particular timestamps, or various other parameters. In some embodiments, the query process module 210 may also perform one or more operations on the retrieved records, for example by applying filters, performing mathematical operations (e.g., averaging returned values for a particular field of matching records), and so forth. Responsive to receiving a query, the query processing module 210 identifies transactions relevant to the received query by accessing a transaction table 225 of the transaction data store 220 to identify relevant transactions. Relevant transactions may be determined based on a validity associated with the transactions, as well as based on a timestamp associated with a transaction being appended or modified, such that only valid, up to date transactions are considered for responding to the query by the query processing module 210.

The query processing module 210 identifies a set of relevant transactions from the filtered transactions based on the received query. Different transactions may have different portions of relevant data in a particular data table. The query processing module 210 determines which transactions are relevant for responding to the query and executes the query on the data tables.

In another example, for a query to retrieve data generated and stored to the data management system 130 within a set timeframe, the query processing module 210 may identify a set of transactions within the specified timeframe.

Based on the identified transaction information in the transaction table 225, the query processing module 210 accesses corresponding data entries stored in the data tables 230. The query processing module 210 applies the received query to the data to generate a query response, which may be returned to the querying device 118. In various embodiments, the query processing module 210 may apply one or more operations or additional downstream processes to the query response prior to returning the query response to the querying device 118, e.g., applying one or more formatting processes. In some embodiments, the query processing module 210 additionally generates a record of the query to be stored in the transaction table 225, such that later audit logs include a record of the query being performed.

To resolve a query for relevant transactions, the query processing module 210 may also resolve which transaction is used when multiple transactions have data relating to identical or duplicate identifiers. For example, in many cases a later-recorded transaction for a particular identifier in a data table is intended to replace a previous transaction for that identifier. For example, for a query specifying data corresponding to a set of record identifiers 1-500, the query processing module 210 may identify a set of three valid transactions that are associated with records in that range of records (e.g., a first transaction associated with records 1-150, a second associated with 101-250, and a third associated with 200-500). In one embodiment, results from all transactions are returned in response to the query. In another embodiment, the records are de-duplicated such that the results from only one transaction per-identifier are processed for the query. For example, when the transactions are prioritized by date, data records for the latest-recorded transaction may be selected for the query. In this example for a query with identifiers 1-500, the records with identifiers 101 through 150 are present in transactions 1 and 2, such that the later-recorded transaction is used for data of these data records. Similarly, transactions 2 and 3 both contain records for identifiers 200-250, such that the data records for the later-recorded transaction is used to resolve queries. In various configurations, if transaction 2 is subsequently invalidated, the data records for transactions 1 and 3 may still be used to resolve queries for queries that might have used transaction 2's data (e.g., if transaction 2 was the last recorded transaction and would be prioritized). In this circumstance, if transaction 2 was the last recorded transaction, for a query for identifiers 1-500, identifiers 1-150 are resolved with transaction 1, identifiers 200-500 are resolved with transaction 3, and no data may be returned for identifiers 151-199.

The validity modification module 215 maintains and updates validity statuses corresponding to transactions in the transaction data store 220. In some embodiments, the validity modification module 215 may invalidate transactions responsive to a manual request by a storing device 116 or another client device to invalidate one or more data entries stored in the data management system 130. In other embodiments, the validity modification module 215 may generate requests to invalidate transactions automatically, e.g., responsive to a process applied to one or more data entries of the data management system 130 failing to execute successfully. For example, the validity modification module 215 may invalidate a transaction responsive to a set of data entries failing to successfully append.

Responsive to identifying a request to modify a validity status of a transaction, the validity modification module 215 accesses the transaction table 225. In some examples, the validity modification module 215 may be provided a transaction identifier to mark as invalid (e.g., in cases where the transaction identifier is specified by a manual request, or in cases wherein the transaction identifier is associated with failed execution of a process). In other examples, the validity modification module 215 may be provided with other metadata describing a transaction to mark as invalid, e.g., to invalidate a most recent data entry for a specified record or set of records. The validity modification module 215 identifies a transaction to be marked as invalid by filtering the transaction table 225 to identify currently valid, up to date transactions and determining, from the filtered transactions, a transaction identifier corresponding to the data entry or data entries to be marked as invalid. As another example, the request to invalidate a transaction may indicate the transaction identifier of the transaction to be invalidated.

To maintain auditable logs of data changes of the data management system 130, the validity modification module 215 in one embodiment generates new records to mark transactions as invalid. That is, an additional entry may be used to mark the transaction invalid, rather than modifying the validity status of the transaction in an existing entry. In various embodiments, the transaction table 225 may be an append-only table, such that previous records for the transactions cannot be modified. The validity modification module 215 creates and stores, for each transaction to be invalidated, a new record including the transaction identifier, a timestamp for the new record, and an “invalidated” validity status. Data entries corresponding to the invalidated transactions are thus no longer able to be queried but are still maintained by the plurality of data tables 230 for later auditing purposes.

The transaction data store 220 stores and maintains data in one or more transaction tables 225 and a plurality of data tables 230. In various embodiments, transaction table(s) 225 and data table(s) 230 of the transaction data store 220 are append-only, such that the data may be appended to the data tables but cannot be modified or deleted.

The data tables 230 store and maintain data entries of the data management system 130. Importantly, multiple data tables 230 may include data entries for a single transaction received by the data management system 130, such that different data entries from within a transaction, e.g., data entries having different types or formats, may be stored in different data tables of the multiple data tables. Further, each data table of the multiple data tables may include an entry or set of entries for each transaction. The data entries may be associated with one or more identifiers corresponding to a unique transaction received by the data management system 130 in addition to one or more record identifiers generated by upstream data generation processes.

When the plurality of data tables 230 are append-only (and stored data entries cannot be modified or deleted), the data tables 230 maintain a complete record of all data appended by the data management system 130. Access to data entries within the data tables 230 (e.g., by querying) is, instead, determined by transaction metadata contained in the transaction table 225. As discussed below, rather than directly querying the data tables, queries for data records are first processed in conjunction with the transaction table 225 to identify valid transactions and respond to the query with data records associated with the valid transactions.

The transaction table 225 stores transaction metadata describing data tables 230 and provides a record or index of data stored in one or more data tables and changes or processes applied to the data. In some embodiments, for example, a transaction table 225 stores transaction metadata describing all data from a given data source, e.g., all data associated with a given computer model or transmitted via a particular storing device 116, and/or all data stored by a given set of data tables 230. The transaction table 225 describes each transaction received by the data management system 130 and each corresponding process applied to the transactions, such as, for example, appends of data to the data tables 230, queries of data in the data tables, invalidation of data in the data tables, or other data changes. For each process, a record is generated and stored in the transaction table 225 including, for example, a transaction identifier, a timestamp of one or more processes applied to the transaction, and a validity indicating whether the corresponding data may be queried.

### Appending, Querying, and Invalidating Data

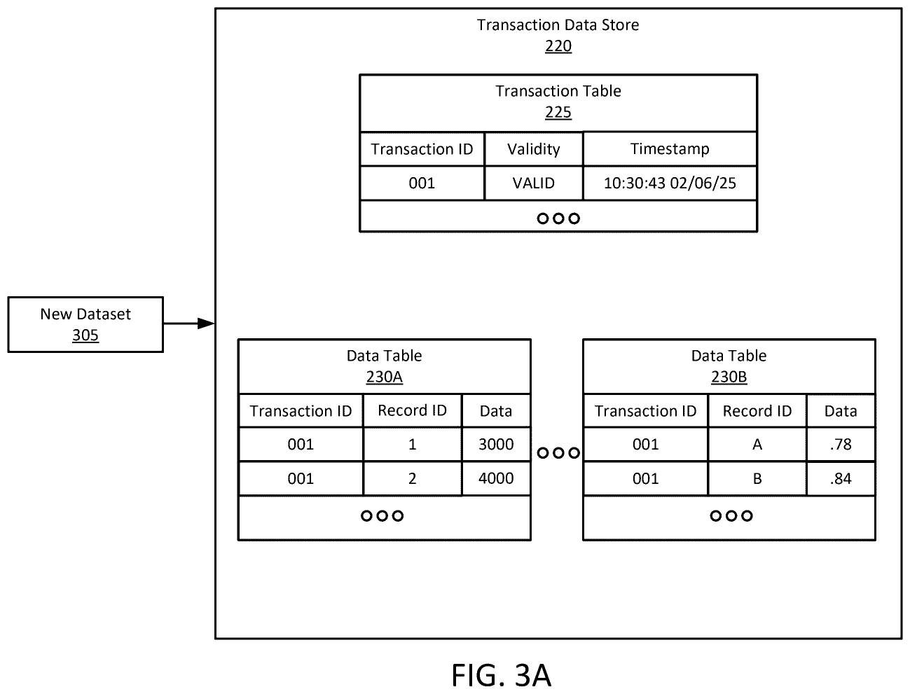

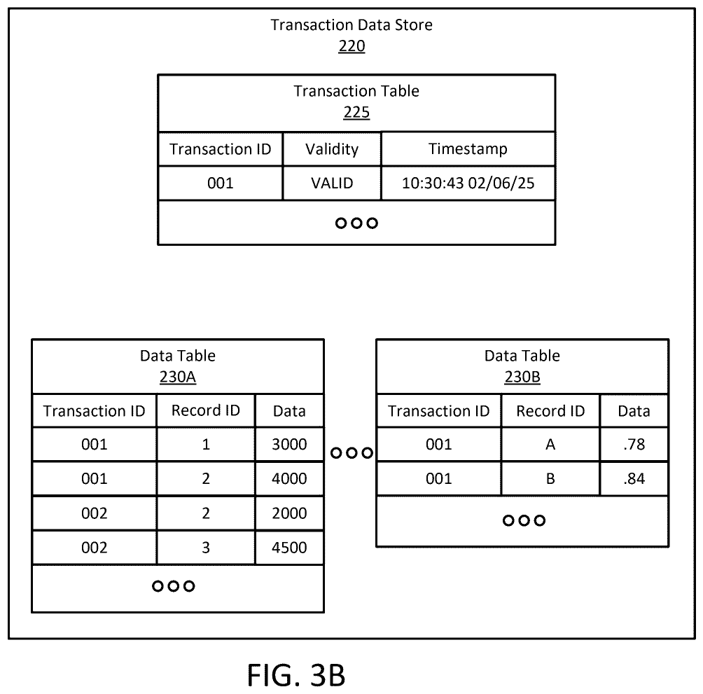

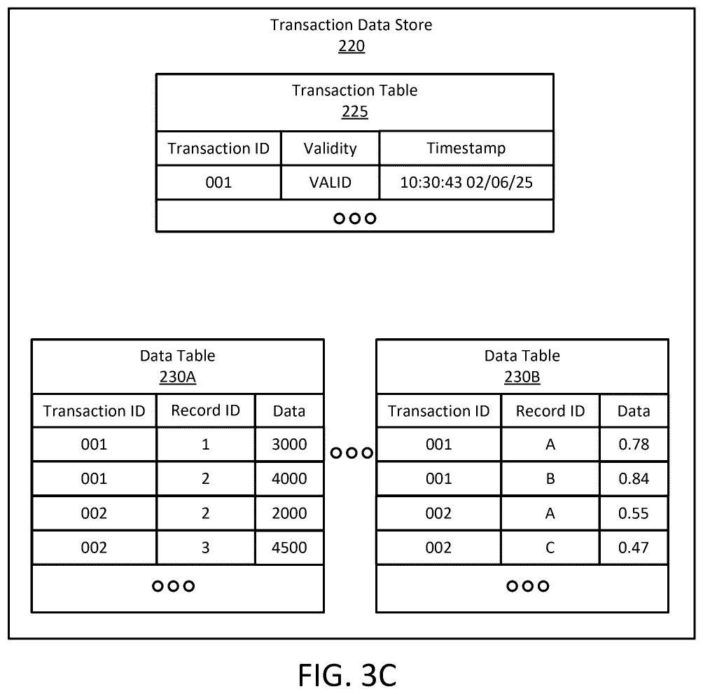

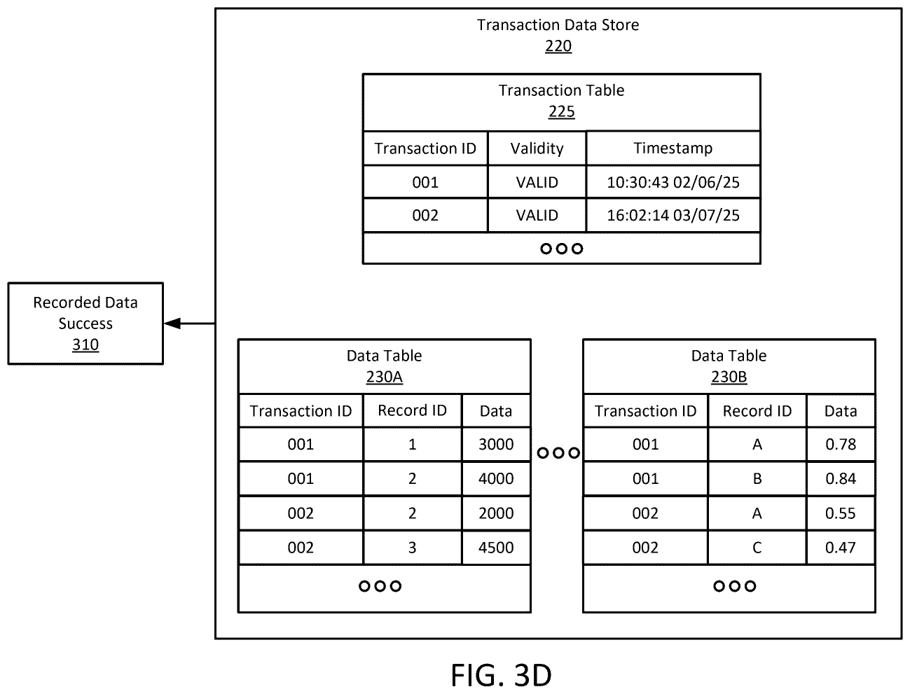

FIGS. 3A-D illustrate appending to an example transaction data store 220 including data tables 230A-B and transaction table 225, according to one embodiment. In particular, FIG. 3A illustrates an example transaction data store 220 including data for a first transaction (transaction ID 001) before storing data relating to a new dataset 305 received by the data management system 130. Data for a first transaction, appended at a prior time, is stored in data tables 230A-230B. Two data tables 230A-B are shown in FIGS. 3A-D; in practice any number of additional data tables 230 may be included in various embodiments having different fields. As shown, the different data tables may include data having different formats, fields, or representing different variables or values and may include data for multiple records and/or different identifiers. For example, data for the first transaction may be generated by an invocation of a trained computer model, such that data table 230A comprises input data to the computer trained model for record IDs 1, 2, while data table 230B comprises output data from the computer trained model for record IDs 1, 2. In additional embodiments, one or more further data tables may additionally include, for example, information describing parameters of the computer trained model at a time that the data was generated.

Transaction table 225 stores data describing transactions stored by the transaction data store 220. In the example of FIG. 3A, the transaction table 225 includes a transaction ID of the first transaction and a validity status (“VALID”) of the first transaction, indicating that the data corresponding to the first transaction is available to be queried. As shown in FIGS. 3B-3D, the data tables 230A-B are updated with the new dataset 305 before indicating that the new dataset 305 is valid (and thus available for querying) in transaction table 225. In some embodiments, to indicate receipt of the new data set 305, an initial entry may be made in the transaction table 225 indicating that the transaction is invalid to expressly prevent use of the transaction data until a later entry indicates the transaction data is valid.

FIG. 3B illustrates the example transaction data store 220 as the new dataset 305 of FIG. 3A is appended to data table 230A. Initially, a transaction identifier of the new data set 305 is determined which uniquely identifies the data being recorded. The transaction identifier may be assigned (e.g., sequentially) or may be a hash value of the data to be recorded (e.g., with a collision-resistant hash function applied to the new data set 305) or another suitable means for uniquely identifying the transaction. In the example of FIG. 3B, data relating to record IDs 2 and 3 is successfully appended to a first data table 230A with the determined transaction identifier. Storage to the plurality of data tables 230 may not occur sequentially or simultaneously, particularly with large or complex datasets. As such, one or more other entries of the new dataset 305 may not be successfully appended to the corresponding data tables at the time of the successful append to the first data table 230A. In this example, data table 230A completes storage before data to data table 230B, which at this point contains only the data for the first transaction.

Because not all data from the new dataset 305 is successfully appended, the transaction table 225 is not yet updated to mark the data corresponding to the new transaction as valid for querying. This ensures that any incoming queries during the append process cannot access or return the partially appended data of the new dataset 305, which may result in data corruption, loss of data, or incorrect query responses that may be incorrectly used by downstream querying systems.

FIG. 3C illustrates the example transaction data store 220 as the new dataset 305 is successfully appended to data table 230B. Continuing the example of FIG. 3B, data entries for the new dataset are appended to data table 230B corresponding to record identifiers. In other examples, additional data entries may be appended to one or more other data tables of the transaction data store, and the data entries may not be appended sequentially.

FIG. 3D illustrates the example transaction data store 220 after the transaction table 225 is updated to include the new dataset 305 after all data tables for the transaction are updated. After all data of the dataset is successfully appended to corresponding data tables 230 of the plurality of data tables, the transaction data store 220 inserts an entry to the transaction table 225, including the transaction ID (002) for the newly appended data, and a corresponding validity status (“VALID”). When the transaction is included in the transaction table 225 with a “valid” status, queries processed by the data management system 130 use data corresponding to the transaction. Because the transaction is marked as “valid” only after all data entries are successfully appended to all relevant data tables 230, queries to the data management system 130 processed before recording the transaction valid in the transaction table are unable to access partially appended data for the transaction. Thus, although data is not appended simultaneously to the plurality of data tables 230, the data management system nevertheless ensures that timing issues arising from receiving queries during append processes does not negatively affect the accuracy of query responses.

In various embodiments, different transactions may include data corresponding to overlapping records. In the example of FIG. 3D, multiple data tables 230 include multiple transactions (001, 002) including data records corresponding to a same identifier (record ID 2 in a first data table 230A and record ID A in a second data table 230B). In the transaction table 225, both transactions are associated with “valid” statuses, and as such, data from both transactions 001, 002 may be accessed for queries received by the data management system 130 and considered “available” for responding to queries. However, for certain fields, such as identifiers or other keys for accessing unique data records, subsequent transactions with the same identifier are typically intended to modify or update the record with the data included in the subsequent transaction. That is, when multiple valid transactions include data records with the same identifier, the returned data typically is prioritized to return the data records associated with the most recent transaction. To resolve queries for multiple retrieved data records having the same identifiers, the transaction table 225 stores timestamps of data appends, modifications, or other processes, such that transactions may be filtered and compared for transaction and data record selection.

In the example of FIG. 2, a query for data associated with record 2 from data table 230A may initially identify separate data records for different valid transactions: one associated with transaction 001 and another associated with transaction 002. Rather than return both data records, the query response identifies transaction 002 as the most current valid transaction and retrieves data from transaction 002 for responding to the query. In this way, queries against the data tables may be resolved with respect to valid transactions while enabling individual data records to be modified by subsequent transactions. In this way, rather than the data tables directly maintaining the “current” value for particular data records, the relevant value for a record is determined at query time by resolving data queries against data records for valid transactions.

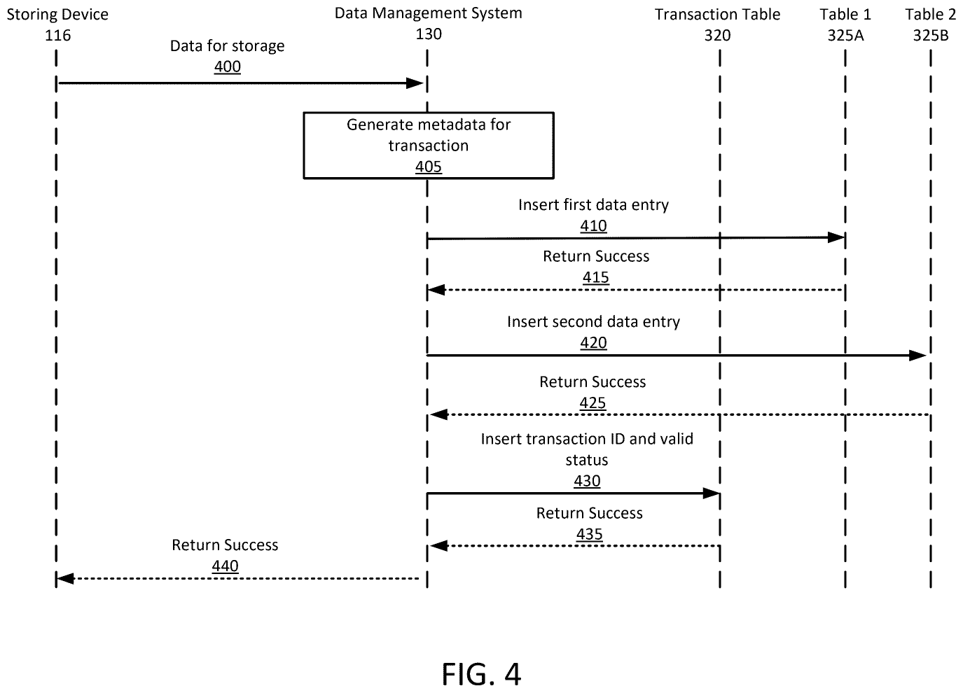

FIG. 4 is an example timing diagram for appending new data to a data management system 130, according to one embodiment. A storing device 116 transmits data 400 to the data management system 130 for storage. The request for data storage may additionally comprise information describing the data, such as identification of a source associated with the data, a location for the data to be stored on the data management system 130, formatting requirements or parameters associated with the data, or the like. The data may include multiple data types and/or formats. For example, data generated by application (i.e., a “run” or “invocation”) of a trained computer model to a batch of data may comprise the batch of inputs to the computer model, the outputs from the computer model, and one or more sets of configurations and/or parameters associated with the computer model at the time of data generation.

Responsive to receiving the data, the data management system 130 generates 405 transaction metadata describing the transaction. For example, the data management system 130 generates a unique transaction identifier for the data and a timestamp of receipt of the data. In other examples, the data management system 130 may generate additional metadata, such as an identifier of the storing device 116, an identifier of a source of the data (e.g., a model identifier), or the like.

To store the received data, the applicable data tables are identified and updated with the respective data entries for each data table. Each data entry may include a plurality of data records for a given transaction. The data management system 130 inserts 410 a first data entry into a first table 325A of a plurality of data tables. After successfully storing the first data entry, the first table 325A returns 415 a success to the data management system 130. In various embodiments, a success notification may include a transaction identifier or other identifying metadata. The data management system 130 inserts 420 a second data entry into a second table 325B and results in a corresponding success 425. The data management system 130 continues to insert data entries into respective data tables for the received data. In various embodiments, appending data entries may be performed in any order (e.g., is not necessarily performed sequentially with respect to the data as received or to an order of the data tables 325). Likewise, appending a data entry to a data table may or may not be performed subsequent to a prior data entry being successfully appended to a different data table, but rather may be initiated while a prior data entry is in the process of appending, such that multiple appends may be simultaneously ongoing (but not necessarily initiated or completed simultaneously).

After successfully adding the data entries to applicable data tables 325, the data management system 130 inserts the generated transaction identifier and validity status 430 into a transaction table 320. In some embodiments, the data management system 130 may insert other transaction metadata into the transaction table 320, such as a timestamp of data receipt or an identifier corresponding to the storing device 116. When all data entries of the dataset are successfully appended, the validity status of the transaction is marked as valid, thus enabling the appended data to be queried. After the transaction table 320 is updated to include the transaction identifier and validity status, the transaction table returns 435 a success to the data management system 130. The data management system 130 returns 440 a success to the storing device 116. In addition to confirming the data set was successfully stored, the data management system 130 may also indicate the transaction identifier of the stored transaction.

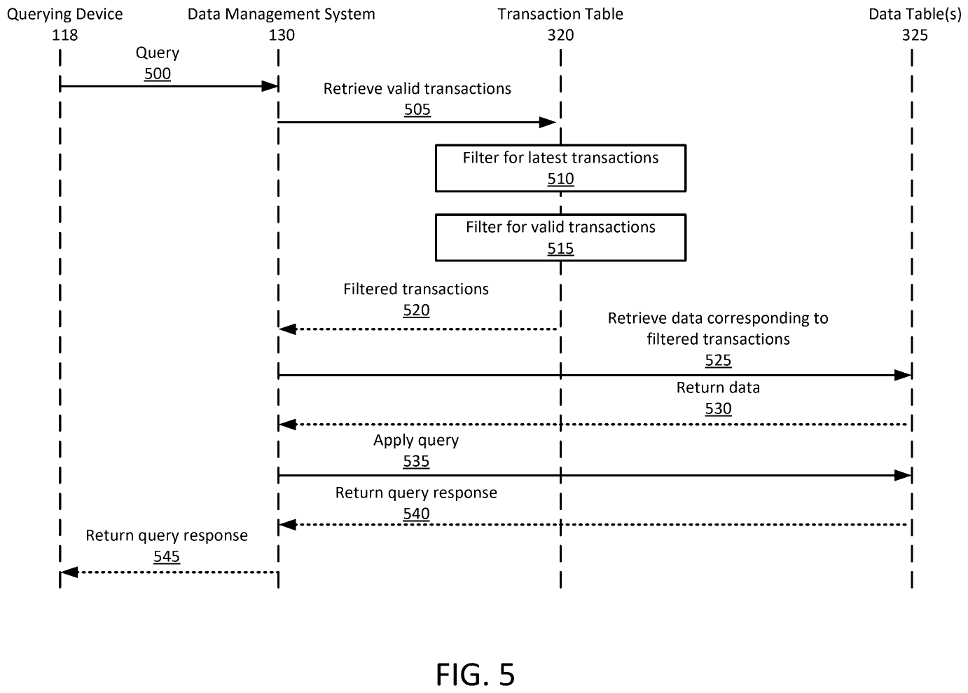

FIG. 5 is an example timing diagram for querying data from a data management system 130, according to one embodiment. A querying device 118 transmits a query 500 to the data management system 130. Queries to the data management system 130 are typically based on data as stored in the plurality of data tables 325, rather than on transaction tables 320, and may not specify a transaction identifier for the queried data. The query may include one or more query parameters for data to be retrieved, such as relevant data tables, data record identifiers (e.g., one or more keys), conditions, timestamps for the data generation and/or storage, identifiers associated with the data, or the like, as well as one or more processes or operations to be applied to the data. Because the plurality of data tables 325 may include records for both valid and invalid transactions, the data management system 130 must identify only valid data from among the data tables 325 prior to executing received queries. In embodiments where the plurality of data tables 325 includes multiple transactions corresponding to a same operation, e.g., to a given run or invocation of a computer trained model, the data management system 130 must additionally identify a latest transaction of a set of transactions.

The data management system 130 transmits a request to retrieve valid transactions 505 to a transaction table 320. In cases where transactions may be duplicated or multiple transactions may otherwise represent a same set of data (e.g., the same run of a machine-learning model), the data management system 130 may aggregate the duplicated transactions and filter each set of duplicated transactions by timestamp to identify a set of transactions that represents the latest 510 and valid set of transactions stored to the data management system 130. The transaction table 320 returns information describing the filtered transactions 520 to the data management system 130. For example, the transaction table 320 returns one or more transaction identifiers corresponding to the filtered transactions 520 to the data management system 130.

The data management system 130 retrieves 525 data corresponding to the filtered transactions to one or more data tables 325 to identify a set of the filtered transactions relevant to the received query. For example, for a query requesting a set of data records, the data management system 130 retrieves information describing data records included in each of the filtered transactions and determines, based on the received query, which of the filtered transactions includes relevant data records for return to the querying device 118. In another example, for a query requesting data records within a set timeframe (e.g., all data generated on a certain date or set of dates), the data management system 130 retrieves information describing timestamps corresponding to the filtered transactions and determines which of the filtered transactions is included within the set timeframe for the query.

The data management system 130 applies 535 the received query to the data corresponding to the set of filtered transactions to retrieve or generate the requested data and returns a query response 540. The data management system 130 then returns the query response 545 to the querying device 118.

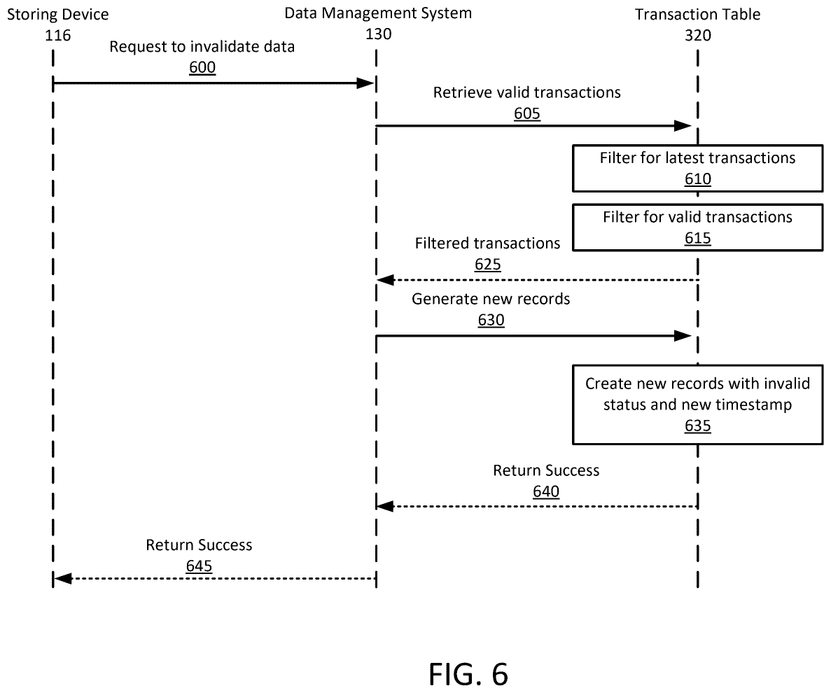

FIG. 6 is an example timing diagram for invalidating transactions in a data management system 130, according to one embodiment. As previously noted, transactions may be invalidated in the data management system 130 for various reasons. For example, data entries may be determined to be incorrect or erroneous and should not be relied on. In the example embodiment of FIG. 6, transactions in the data management system 130 may be manually invalidated by a user via a storing device 116 or another client device suitable for transmitting data to the data management system. In other embodiments, transactions in the data management system 130 may be automatically invalidated by the data management system if a transaction fails prior to being fully appended or if data in a transaction is determined to be duplicated from an earlier appended transaction. In these cases, it is undesirable for the transactions to be passed to downstream systems when the data management system 130 is queried, but valuable for the transactions to be maintained in the data management system for audit purposes.

The storing device 116 transmits a request to invalidate data 600 to the data management system 130. In various embodiments, the request to invalidate data may specify a transaction identifier, record identifier, associated timestamps, or other metadata describing the transaction for invalidation. In some embodiments, the request to invalidate data may specify a set of transactions corresponding to a particular run or invocation of a computer trained model, e.g., by providing a run identifier to be invalidated. The data management system 130 transmits a request for valid transactions 605 corresponding to the data to be invalidated from the transaction table 320. For example, in the case where a run identifier is provided for invalidation, the data management system 130 retrieves all transactions corresponding to the run identifier from the transaction table 320. The transaction table 320 may be further filtered for latest transactions 610 and then for valid transactions 615, such that only up-to-date and valid transactions are selected. Data describing the filtered transactions are returned 620 to the data management system 130. For example, the transaction table 320 may return a set of transaction identifiers corresponding to the filtered transactions 625 to the data management system 130. In other examples, the transaction table 320 may additionally or instead return record identifiers associated with the filtered transactions or other metadata describing the filtered transactions to the data management system 130.

In various embodiments, the transaction table 320 is an append-only data table, and entries in the transaction table 320 cannot be modified or deleted. To invalidate the requested data, the data management system 130 generates new records 630 for the transaction identifiers to be invalidated, the new records having an updated invalidated status and a new timestamp representing the time of invalidation. Because data is invalidated by marking transactions as invalid in the transaction table 320, in these embodiments, transactions are not partially invalidated. That is, an individual data entry or data record within a transaction is not marked as alone; rather, the associated data entry is invalidated by invalidating the transaction as a whole, which invalidates the other data entries across data tables for that same transaction. As such, to correct a particular data record, a subsequent transaction for that record is provided for storage.

The new record or set of records are created 635 in the transaction table 320. When a set of records is created in the transaction table 320 (as when transactions are invalidated), the records may be updated in the transaction table as a single atomic operation. Because previous records corresponding to the transactions are not modified or deleted, the transaction table 320 contains, for invalidated transactions, a later-recorded record having the invalidated status. Later queries to the data management system 130 will identify the transaction as being invalid based on the more recent record for the transaction and will not access data corresponding to the transaction for generating query responses. Responsive to the new record being appended successfully to the transaction table 320, the transaction table returns a success 640 to the data management system 130. The data management system 130 returns a success 645 to the storing device 116.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A data management system comprising:
a processor; and
a non-transitory computer-readable storage medium having instructions executable by the processor for:
identifying a database having a plurality of data tables and a transaction table, the transaction table specifying a set of transactions and whether each transaction is valid or invalid;
receiving a request to store data to a plurality of separate data tables, the request specifying a first data entry for a first data table and a second data entry for a second data table;
determining a transaction identifier for the request;
storing the first data entry in the first data table in association with the transaction identifier;
storing the second data entry in the second data table in association with the transaction identifier; and
after storing the first and second data entries, storing the transaction identifier in the transaction table indicating that the transaction identifier is valid, wherein queries to the database are executed on transactions indicated as valid in the transaction table.

2. The system of claim 1, wherein the instructions for the data management system are further executable for:
receiving, from a querying system, a query to the database;
accessing the transaction table;
filtering data in the transaction table to identify one or more transactions, each of the one or more transactions indicated as valid and associated with respective transaction identifiers;
retrieving, from the plurality of data tables, data associated with the one or more transaction identifiers;
applying the received query to the retrieved data to generate a query response; and
transmitting the query response to the querying system.

3. The system of claim 1, wherein transactions to the plurality of data tables of the database are not jointly idempotent.

4. The system of claim 1, wherein the data is an output of a trained computer model.

5. The system of claim 1, wherein the instructions for the data management system are further executable for:
receiving, from a client device, a request to invalidate a transaction;
accessing the transaction table;
filtering data in the transaction table to identify the transaction, the transaction indicated as valid and associated with a transaction identifier; and
storing the transaction identifier as a new record in the transaction table, the new record associated with a new timestamp and indicating that the transaction is invalid.

6. The system of claim 5, wherein the transaction is invalidated because at least one of the data entries corresponding to the transaction identifier is erroneous.

7. The system of claim 6, wherein at least one other data entry corresponding to the transaction identifier is not erroneous.

8. The system of claim 5, wherein an earlier timestamped transaction representing the same data as the invalidated transaction is retrieved responsive to a query to the data management system.

9. A method for a data management system, comprising:
identifying a database having a plurality of data tables and a transaction table, the transaction table specifying a set of transactions and whether each transaction is valid or invalid;
receiving a request to store data to a plurality of separate data tables, the request specifying a first data entry for a first data table and a second data entry for a second data table;
determining a transaction identifier for the request;
storing the first data entry in the first data table in association with the transaction identifier;
storing the second data entry in the second data table in association with the transaction identifier; and
after storing the first and second data entries, storing the transaction identifier in the transaction table indicating that the transaction identifier is valid, wherein queries to the database are executed on transactions indicated as valid in the transaction table.

10. The method of claim 9, further comprising:
receiving, from a querying system, a query to the database;
accessing the transaction table;
filtering data in the transaction table to identify one or more transactions, each of the one or more transactions indicated as valid and associated with respective transaction identifiers;
retrieving, from the plurality of data tables, data associated with the one or more transaction identifiers;
applying the received query to the retrieved data to generate a query response; and
transmitting the query response to the querying system.

11. The method of claim 9, wherein transactions to the plurality of data tables of the database are not jointly idempotent.

12. The method of claim 9, wherein the data is an output of a trained computer model.

13. The method of claim 9, further comprising:
receiving, from a client device, a request to invalidate a transaction;
accessing the transaction table;
filtering data in the transaction table to identify the transaction, the transaction indicated as valid and associated with a transaction identifier; and
storing the transaction identifier as a new record in the transaction table, the new record associated with a new timestamp and indicating that the transaction is invalid.

14. The method of claim 13, wherein the transaction is invalidated because at least one of the data entries corresponding to the transaction identifier is erroneous.

15. The method of claim 14, wherein at least one other data entry corresponding to the transaction identifier is not erroneous.

16. The method of claim 13, wherein an earlier timestamped transaction representing the same data as the invalidated transaction is retrieved responsive to a query to the data management system.

17. A non-transitory computer-readable storage medium for a data management system, the non-transitory computer-readable medium comprising instructions that, when executed by a processor, cause the processor to:
identify a database having a plurality of data tables and a transaction table, the transaction table specifying a set of transactions and whether each transaction is valid or invalid;
receive a request to store data to a plurality of separate data tables, the request specifying a first data entry for a first data table and a second data entry for a second data table;
determine a transaction identifier for the request;
store the first data entry in the first data table in association with the transaction identifier;
store the second data entry in the second data table in association with the transaction identifier;
after storing the first and second data entries, storing the transaction identifier in the transaction table indicating that the transaction identifier is valid, wherein queries to the database are executed on transactions indicated as valid in the transaction table.

18. The non-transitory computer-readable medium of claim 17, wherein the instructions further cause the processor to:
receive, from a querying system, a query to the database;
access the transaction table;
filter data in the transaction table to identify one or more transactions, each of the one or more transactions indicated as valid and associated with respective transaction identifiers;
retrieve, from the plurality of data tables, data associated with the one or more transaction identifiers;
apply the received query to the retrieved data to generate a query response; and
transmit the query response to the querying system.

19. The non-transitory computer-readable medium of claim 17, wherein transactions to the plurality of data tables of the database are not jointly idempotent.

20. The non-transitory computer-readable medium of claim 17, wherein the data is an output of a trained computer model.
